(19) United States
(12) Patent Application Publication
(10) Pub. No.: US 2019/0018159 A1
(43) Pub. Date: Jan. 17, 2019

(54) Deployment and Retrieval Method and Apparatus for Seismic Nodal Recording Systems

(71) Applicant: Axxis Geo Solutions AS, Houston, TX (US)

(72) Inventor: Lee Parker, Houston, TX (US)

(73) Assignee: Axxis Geo Solutions AS, Houston, TX (US)

(21) Appl. No.: 15/995,361

(22) Filed: Jun. 1, 2018

Related U.S. Application Data
(60) Provisional application No. 62/532,025, filed on Jul. 13, 2017.

(51) Int. Cl. G01V 1/38; B66D 1/26; B66D 1/40; G01V 1/20

(52) U.S. Cl. CPC G01V 1/3852; B66D 1/26; B63B 35/04; G01V 1/201; B66D 1/40

(57) ABSTRACT

A system and method for deploying seismic data acquisition equipment from a moving vessel. The system and method utilize movable pulley systems to manipulate a string of data acquisition equipment such that a technician may attach the seismic data acquisition equipment to a rope or cable during a period in which the rope or cable is stationary relative to the vessel. The system and method allow for equipment deployment at a relatively constant rate while the vessel maintains a relatively constant velocity. The system and method for deploying seismic data acquisition equipment allows for enhanced personnel safety and efficient equipment deployment.

### CROSS REFERENCE TO RELATED APPLICATION

This application claims priority to and all the benefits of U.S. Provisional Application Ser. No. 62/532,025, filed on Jul. 13, 2017 and entitled “Deployment and Retrieval Method and Apparatus for Seismic Nodal Recording Systems.”

### FIELD OF THE INVENTION

The present invention relates to seismic data acquisition systems used in the marine environment and, in particular, to systems designed to deploy and retrieve seismic acquisition equipment into and from the water.

### BACKGROUND OF THE INVENTION

Seismic data acquisition is used to generate images of geologic structures beneath the Earth's surface. In general practice, sensitive sensors are placed at or near the surface of the Earth. Once the sensors are in the desired positions, a seismic source is initiated which imparts acoustic waves into the rocks and structures beneath the Earth's surface. When the acoustic waves encounter a boundary within the Earth, such as the boundary between two different layers of stratum, a portion of the acoustic wave is reflected back towards the surface of the Earth where the wave is detected by the sensors. The data generated by the sensors is stored and analyzed. By analyzing the recorded data from the seismic sensor, a geophysicist can then generate an image representative of the geologic structures beneath the Earth's surface.

It is sometimes necessary to deploy seismic sensors, the seismic source, or both within a body of water. In these cases, the seismic data acquisition is known as marine seismic data acquisition.

In certain cases of marine seismic data acquisition, it is desirable to place the sensors on the seafloor. In these cases, one of several different types of seismic detectors and recorders may be employed. One such system is referred to as a nodal recording system.

The nodes, or seismic collection devices are typically self-contained units which encompass some or all of the following: one or more geophones, one or more hydrophones, one or more MEMS accelerometers, digital recording electronics, data storage media, timing circuitry and a battery. To aid in the deployment and retrieval of these nodes, they are often connected with cables, ropes or other suitable materials with a specified length between adjacent nodes. This method of connecting nodes is sometimes referred to as “nodes on a rope.” The connected nodes are typically deployed from the stern of a vessel moving through the water at a speed optimized for deploying the nodes at the desired length between adjacent nodes on the seafloor.

The current practice of deploying nodes into the water and onto the sea floor begins with having the cable stored on a reel on the vessel or laid out in an organized fashion on the deck of the vessel. The nodes are stored near a path between the stored cable and the stern of the vessel. An end of the cable is then deployed into the water, often with a weight attached to the end of the cable and the cable is deployed into the water as the vessel moves forward. At specified intervals, nodes are attached to the cable and are deployed off the stern of the vessel along with the cable and settle to the seafloor.

Some previous methods for deploying nodes from a vessel, such as that described by Ray et al. in U.S. Pat. No. 7,990,803 B2, involve a means for attaching the node to the rope or cable while the vessel moves. While the act of attaching the node to the cable is typically accomplished manually by a technician, some attempts have been made to create mechanisms to automatically perform this function. During a typical deployment operation, the vessel is traveling through the water at a speed between 2 and 6 knots or about 1 to 3 meters per second. As the vessel is traveling in a forward direction, the cable with the connected nodes is deployed from the stern of the vessel. As the cable is being deployed, it is relatively stationary with respect to the body of water into which it is being deployed. And since the vessel is moving through the water, the cable has a speed relative to the vessel roughly equal to the speed of the vessel. It is neither practical nor safe to manually attach seismic nodes to a cable while the vessel is traveling at this rate of speed. Attempting to eliminate these problems, some previous deployment systems used a method of slowing or stopping the forward progress of the vessel or stopping or slowing the rate at which the cable is released from the cable storage device, or both, providing a momentary pause in the motion of the cable relative to the vessel to allow the technician to attach the node to the cable. This complex interaction between cable release speed and vessel forward speed results in a variable rate of cable deployment. Those skilled in the art understand that the optimum conditions for deploying a nodal system are at a constant vessel speed with a constant rate of cable deployment. This provides the best conditions for ensuring that the position of each node and the tension of the cables connecting the nodes are optimum for the given circumstances.

Other prior art methods include a towed deployment device designed to improve the positional accuracy of the nodes on the seafloor as described by Gateman, et al. in U.S. Pat. No. 9,611,018 B2. In these methods, the nodes may be manually attached to the cable during deployment or may be pre-attached to and stored with the cable in the deployment device which is then towed behind the vessel. A potential disadvantage of this method is the requirement fora large mechanical device with multiple operational functions that is towed behind the vessel. Deployment and retrieval of such large devices can be complicated and may present significant risk for personnel and equipment involved in the operation.

A deployment method and apparatus that allows the vessel to travel at a constant speed, allows the cable to be deployed at a constant speed, and provides a period of time during which the cable is stationary relative to a workstation would permit an operator to attach the nodes to the cable more safely than the prior art solutions.

### SUMMARY OF THE INVENTION

The present invention provides an apparatus and method for deploying a nodal recording system from a vessel at a constant vessel speed and a constant cable deployment speed while providing a time period in which the cable is stationary relative to a workstation where a technician can safely attach nodes to the cable.

The concept of the invention is based on the workings of pulley and belt systems and, more specifically, the concept of a movable take-up pulley. A take-up pulley is a pulley capable of changing locations during operation (as opposed to a standard pulley that can only move rotationally during operation). A common implementation of a take-up pulley is shown in FIG. 1 in which there is a continuous belt (101), a head pulley (102), a number of idler rollers (103), several bend pulleys (104), a tail pulley (105), a snub pulley (106) and a take-up pulley (107). The head pulley (102) is generally at the discharge end of the conveyor system and can either be a drive pulley, which provides the driving force to the conveyor system or it can be an idler pulley, which does not provide driving force. Idler rollers (103) generally provide direction, but do not provide drive to the conveyor system. Bend pulleys generally allow the conveyor to change direction. The tail pulley (105) is generally located at the tail end of the conveyor system and may either be a drive pulley or an idler pulley. And the snub pulley (106) is generally used to increase the arc of contact of the belt with the drive pulley (102).

This basic configuration can be changed to accommodate a cable on a reel dispensing the cable from the stern of a vessel as shown in FIG. 2. In FIG. 2, there is a cable reel (201) holding a length of cable (202), several bend pulleys (203) used to change the direction of the cable, a deployment pulley (204) from which the cable is deployed, and a take-up pulley (205) that may change locations during operation. In this figure, if the cable reel is dispensing the cable at a speed V (211), the cable will be moving at the same speed V (212) as is passes over the deployment pulley (204).

Changing the position of the take-up pulley (205) while the reel (201) is dispensing cable (202) changes the speed that the cable moves over the deployment pulley (204). This is demonstrated in FIG. 3 where the cable reel (301) is dispensing cable at a rate of V (311) meters/second and the take-up pulley (305) is moving in the direction of arrow (313) at a rate equal to V*n meters/second where “n” is a positive number. The speed at which the cable passes over the deployment pulley (304) is V−(V*n)*2 (312) meters/second. Moving the take-up pulley (305) in the direction of arrow (313) slows the deployment speed of the cable. If the variable “n” is set equal to 0.5 meters/second, then the speed of the cable moving over the deployment pulley becomes 0 meters/second. And if the value of “n” is negative, effectively moving the take-up pulley in the direction opposite of arrow (313), the speed of the cable as it passes over the deployment pulley increases to a value greater than the speed at which the cable reel is dispensing cable.

### BRIEF DESCRIPTION OF THE DRAWINGS

FIG. 1 is an example of a conveyor system with take-up pulley and a continuous belt;

FIG. 2 is an adaptation of the take-up pulley system of FIG. 1 for a reel dispensing a cable and the cable being deployed off the stern of a vessel;

FIG. 3 is an adaptation of FIG. 2 with the take-up pulley moving in a manner such as to slow the deployment of the cable off the stern of the vessel;

FIG. 4a is an example of an embodiment of the invention at the beginning of the deployment cycle;

FIG. 4b is an embodiment of FIG. 4a where the take-up pulley is moving in a manner with which the speed at which the cable is dispensed and the speed of the cable at the workstation are increased while the speed of deployment of the cable off the stern of the vessel remains constant;

FIG. 4c is an embodiment of FIG. 4a where the take-up pulley is moving in a manner with which the speed at which the cable is dispensed and the speed of the cable at the workstation become essentially zero while the speed of deployment of the cable off the stern of the vessel remains constant;

FIG. 5a is a second preferred embodiment of the invention at the beginning of the deployment cycle;

FIG. 5b is an embodiment of FIG. 5a where the first and second take-up pulleys are moving in a manner with which the speed at which the cable is dispensed and the speed at which the cable is deployed remain constant while the speed of the cable at the workstation increases;

FIG. 5c is an embodiment of FIG. 5a where the first and second take-up pulleys are moving in a manner with which the speed at which the cable is dispensed and the speed at which the cable is deployed remain constant while the speed of the cable at the workstation becomes essentially zero.

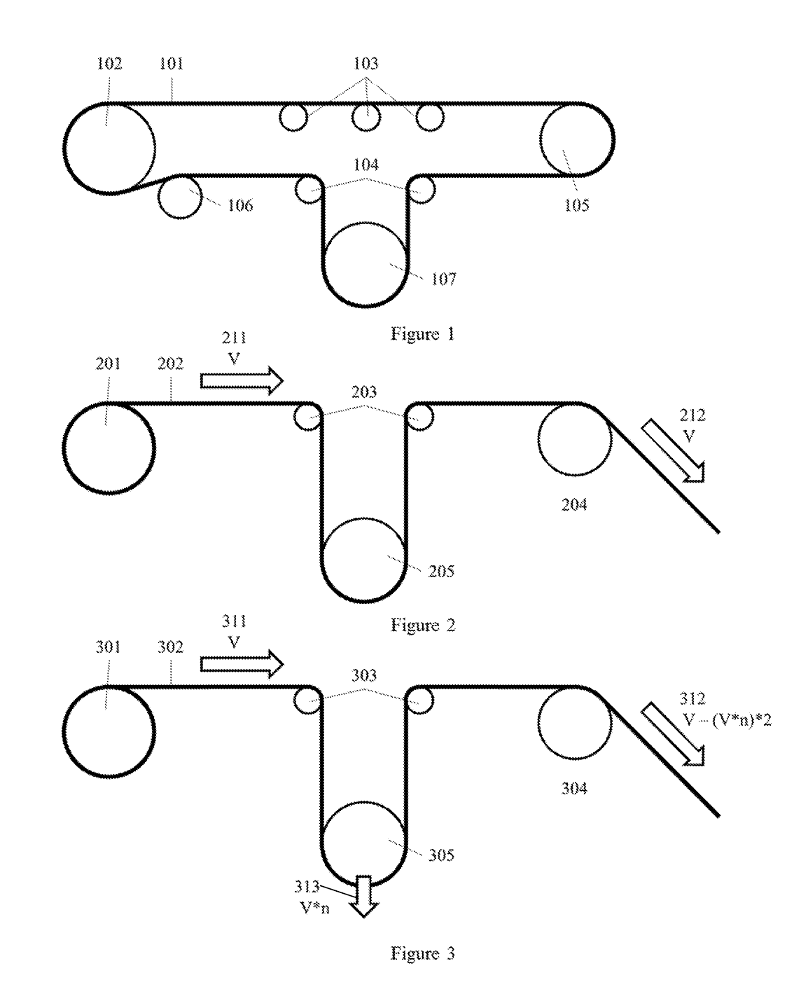

### DETAILED DESCRIPTION OF THE INVENTION

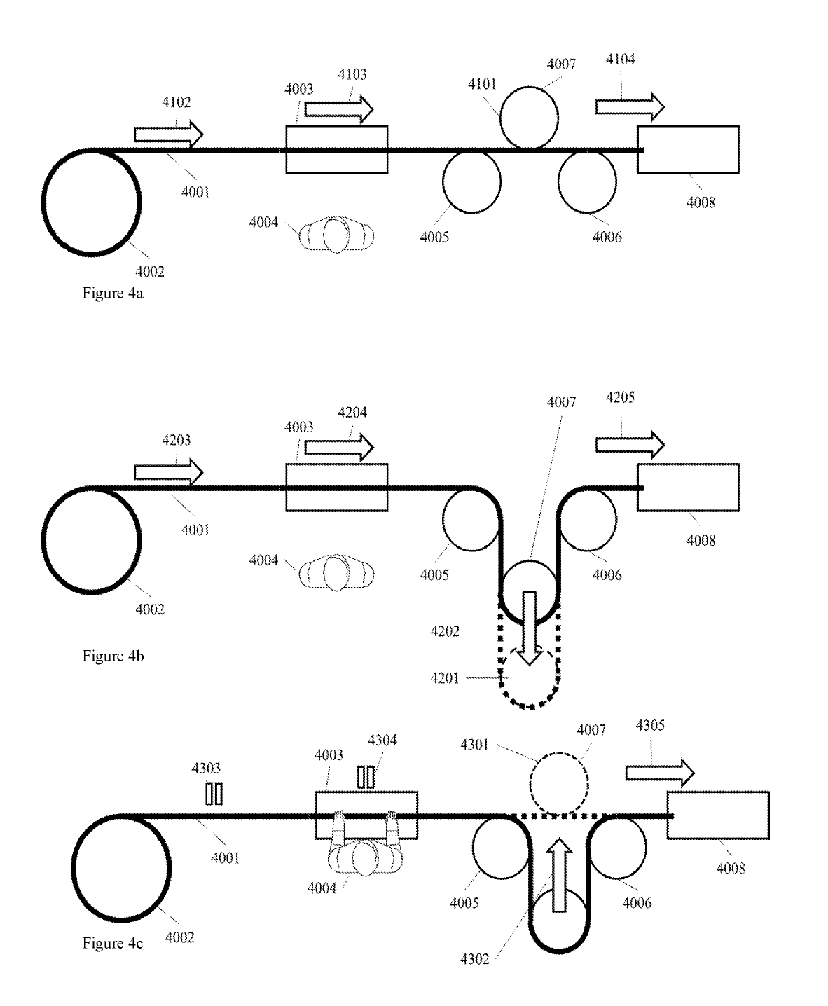

One preferred embodiment of the current invention is shown in FIGS. 4a-4c. In these figures, there is a cable (4001) on a cable storage device (4002). In this embodiment the cable storage device (4002) is a reel. This embodiment also includes a work station (4003) where a technician (4004) can attach nodes to the cable (4001). This embodiment further includes 2 bend pulleys (4005 and 4006), a take-up pulley (4007) and a deployment ramp (4008) for node deployment. This embodiment operates through a repeated cycle of steps, each step accomplishing a specific purpose for the deployment of the nodal system. At the beginning of the cycle, shown in FIG. 4a, the take-up pulley (4007) is in a starting position (4101), the cable deployment reel (4002) is dispensing cable at a rate equal to the speed of the vessel (4102). The cable is traveling past the workstation (4003) at rate equal to the speed of the vessel (4103) and the cable is being deployed off the end of the ramp (4008) at a rate equal to the speed of the vessel (4104). As an example, the take-up pulley (4007) moves to the position shown in FIG. 4b (4201) at a rate of one half of the speed of the vessel (4202), the rate at which the reel dispenses cable is increased to a rate twice the speed of the vessel (4203), the cable is traveling past the workstation at a rate twice the speed of the vessel (4204) and the cable is being deployed off the end of the ramp at a rate equal to the speed of the vessel (4205). After a time T1, the take-up pulley moves back to the position shown in FIG. 4c (4301) at a rate of one half the speed of the vessel (4302), the reel stops dispensing cable (4303), the cable is stationary in front of the workstation (4304) and the cable is being deployed off the end of the ramp at a rate equal to the speed of the vessel (4305). The time period Ts, in which the cable is stationary in front of the workstation is equal to the length of time required to move the take-up pulley (4007) from the diverted position shown in FIG. 4b (4201) to the un-diverted position shown in FIG. 4c (4301). The time period Ts can be adjusted by changing the speed of the vessel V1, the distance the take-up pulley diverts the cable D1, or both and is described by the equation Ts=(2*D1)/V1. Scalars other than one half of the vessel speed for the rate at which the take-up pulley diverts the cable can be used and will provide different speeds at which the cable moves past the workstation. These scalars may be suitable for certain implementations of the invention. In FIG. 4a, the take-up pulley (4007) is returned to the initial starting position and conditions. This embodiment accomplishes the goal of providing a period of time where the cable is stationary with respect to the technician (4004) while he or she attaches the node and also maintaining a constant vessel speed and rate of node deployment.

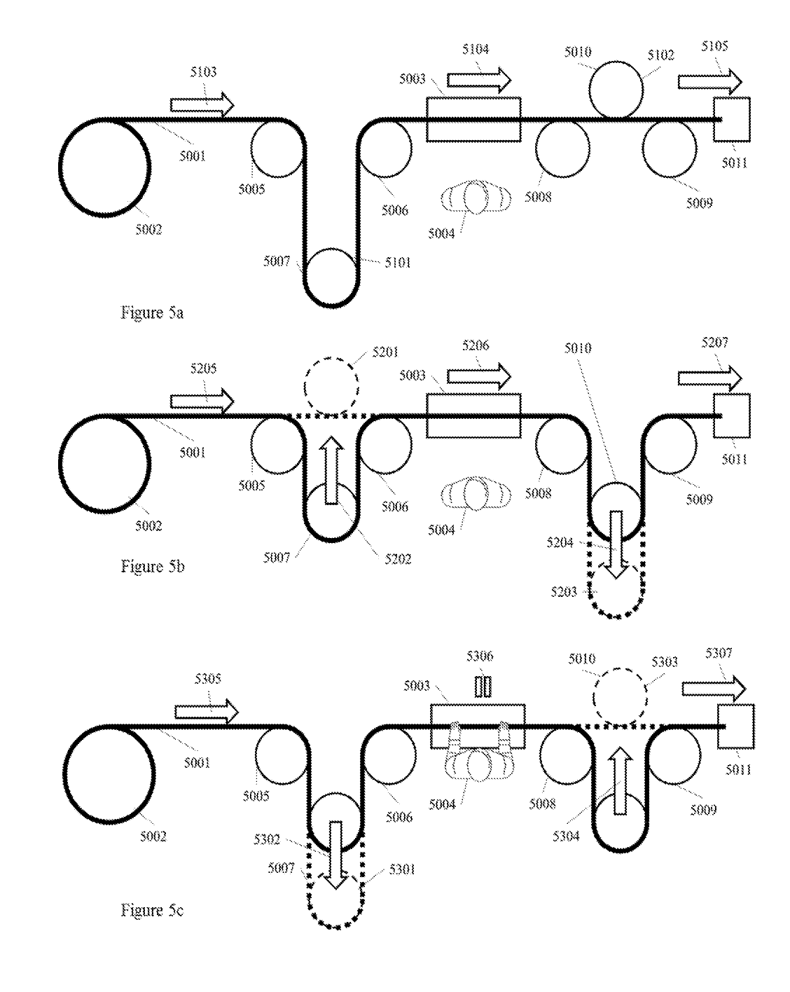

A second embodiment of the current invention is shown in FIGS. 5a-5c. In these figures, there is a cable (5001) on a cable storage device (5002), a work station (5003), a technician (5004), 2 bend pulleys (5005 and 5006), a take-up pulley (5007), two additional bend pulleys (5008 and 5009), an additional take-up pulley (5010) and a deployment ramp (5011). This embodiment operates through a repeated cycle of steps, each step accomplishing a specific purpose for the deployment of the nodal system. At the beginning of the cycle, shown in FIG. 5a, take-up pulley (5007) is in a starting position (5101), take-up pulley (5010) is in a starting position (5102), the cable deployment reel (5002) is dispensing cable at a rate equal to the speed of the vessel (5103), the cable is traveling past the workstation (5104) at a rate equal to the speed of the vessel (5104) and the cable is being deployed off the end of the ramp (5105) at a rate equal to the speed of the vessel (5105). After a time, take-up pulley (5007) moves to the position shown in FIG. 5b (5201) at a rate of one half of the speed of the vessel (5202), take-up pulley (5010) moves to the position shown in FIG. 5b (5203) at a rate of one half of the speed of the vessel (5204), the rate at which the reel dispenses cable remains equal to the speed of the vessel (5205), the cable is traveling past the workstation at a rate of twice the speed of the vessel (5206) and the cable is being deployed off the end of the ramp at a rate equal to the speed of the vessel (5207).

After a time T1, take-up pulley (5007) moves back to the position shown in FIG. 5c (5301) at a rate of one half the speed of the vessel (5302). Take-up pulley (5010) moves back to the position shown in FIG. 5c (5303) at a rate of one half the speed of the vessel (5304), the rate at which the reel dispenses cable remains equal to the speed of the vessel (5305), the cable is stationary in front of the workstation (5306) and the cable is being deployed off the end of the ramp at a rate equal to the speed of the vessel (5307). The time period Ts, in which the cable is stationary in front of the workstation (5306) is equal to the length of time required to move the take-up pulley (5010) from the diverted position shown in FIG. 5b (5203) to the un-diverted position shown in FIG. 5c (5303). The time period Ts can be adjusted by changing the speed of the vessel V1, the distance the take-up pulley diverts the cable D1, or both and is described by the equation Ts=(2*D1)/V1. Scalars other than one half of the vessel speed for the rate at which the take-up pulley diverts the cable can be used and will provide different speeds at which the cable moves past the workstation. These scalars may be suitable for certain embodiments of the invention. In the embodiment of FIG. 5c, the take-up pulleys have returned to the initial starting position and conditions. In this embodiment of the current invention, the goal of providing a period of time where the cable is stationary for the technician to attach a node to the cable while maintaining a constant vessel speed and rate of deployment are all accomplished. In addition, this embodiment allows the cable reel to dispense cable at a constant rate.

The operation of the present invention may also be performed in the opposite direction. The reels disclosed in the embodiments disclosed herein can be used for either dispensing or retrieving cable. By reversing the direction of the relative motion of the cables and pulleys, the present invention can be used to retrieve a deployed cable with attached nodes while maintaining constant vessel speed, constant speed of cable recovery, constant take-up of cable on the reel, and a period of time during which the cable is stationary relative to a workstation, thereby allowing nodes to be safely removed from the cable by a technician.

It should be recognized that the descriptions and terminology used in the preceding discussion and in the following claims are intended to convey the concept of the current invention and not to limit the scope of what is claimed. While several embodiments of the present invention have been disclosed herein, it is to be understood that these embodiments are given by example only and not in a limiting sense. Those skilled in the art may make various modifications and additions to the preferred embodiments without departing from the spirit and scope of the present invention. For example, in the descriptions, the term cable can be understood to mean a steel cable, a rope, a chain or any other device that can be implemented in the same manner within the context of this disclosure. Accordingly, it is to be realized that the patent protection sought and to be afforded hereby shall be deemed to extend to the subject matter claimed and all equivalence thereof fairly within the scope of the invention.

The invention claimed is:

1. A method for deploying seismic data collection equipment from a vessel into a body of water comprising:
a. Providing a cable having a first end and a second end;
b. Providing a cable dispensing and retrieving device at a location between the first and second ends of said cable;
c. Providing a cable diverter mechanism at a location between said cable dispensing and retrieving device and the first end of said cable;
d. Dispensing cable from said cable dispensing and retrieving device and deploying said cable into the body of water;
e. Moving said cable diverter device for a time period T1 in a first direction that diverts a portion of said cable;
f. Moving said cable diverter device for a second time period T2 in a second direction;
g. Attaching one or more of said seismic data collection devices to the cable during said time period T2; and
h. Repeating steps e. through g. until a desired number of seismic collection devices have been deployed.

2. The method of claim 1 wherein the cable diverter mechanism is a take-up pulley.

3. The method of claim 1 wherein the cable diverter mechanism is a spool.

4. The method of claim 1 wherein the cable dispensing and retrieving device is a reel.

5. The method of claim 1 wherein the cable dispensing and retrieving device is a squirter.

6. A method for deploying seismic data collection equipment from a vessel into a body of water comprising:
a. Providing a cable having a first end and a second end;
b. Providing a cable dispensing and retrieving device at a location between the first and second ends of said cable;
c. Providing a first cable diverter mechanism at a location between said cable dispensing and retrieving device and the first end of said cable;
d. Providing a second cable diverter mechanism at a location between said first cable diverter mechanism and the first end of said cable;
e. Dispensing cable from said cable dispensing and retrieving device and deploying said cable into the body of water;
f. Moving said first cable diverter device for a time period T1 in a first direction and simultaneously moving said second cable diverter mechanism for the time period T1 in a second direction;
g. Moving said first cable diverter device for a time period T2 in the second direction, and simultaneously moving said second cable diverter mechanism in the first direction for the time period T2;
h. Attaching one or more of said seismic data collection devices to said cable during the time period T2;
i. Repeating steps f. through h. until a desired number of seismic collection devices have been deployed.

7. The method of claim 6 wherein at least one of said cable diverter mechanisms is a take-up pulley.

8. The method of claim 6 wherein at least one of said cable diverter mechanisms is a spool.

9. The method of claim 6 wherein the cable dispensing and retrieving device is a reel.

10. The method of claim 6 wherein the cable dispensing and retrieving device is a squirter.

11. A method of retrieving seismic data collection equipment from a body of water comprising:
a. Providing a cable having a first end and a second end;
b. Providing a cable dispensing and retrieving device at a location between the first and second ends of said cable;
c. Providing a cable diverter mechanism at a location between said cable dispensing and retrieving device and the first end of said cable;
d. Retrieving cable from the body of water with the cable dispensing and retrieving device;
e. Moving said cable diverter device for a time period T1 in a first direction that diverts a portion of said cable;
f. Moving said cable diverter device for a second time period T2 in a second direction;
g. Removing one or more seismic data collection devices from the cable during said time period T2; and
h. Repeating steps e. through g. until a desired number of seismic collection devices have been retrieved.

12. The method of claim 11 wherein the cable diverter mechanism is a take-up pulley.

13. The method of claim 11 wherein the cable diverter mechanism is a spool.

14. The method of claim 11 wherein the cable dispensing and retrieving device is a reel.

15. The method of claim 11 wherein the cable dispensing and retrieving device is a squirter.

16. A method of retrieving seismic data collection equipment from a body of water comprising:
a. Providing a cable having a first end and a second end;
b. Providing a cable dispensing and retrieving device at a location between the first and second ends of said cable;
c. Providing a first cable diverter mechanism at a location between said cable dispensing and retrieving device and the first end of said cable;
d. Providing a second cable diverter mechanism at a location between said first cable diverter mechanism and the first end of said cable;
e. Retrieving the cable from the body of water with the cable dispensing and retrieving device;
f. Moving said first cable diverter device for a time period T1 in a first direction and simultaneously moving said second cable diverter mechanism for the time period T1 in a second direction;
g. Moving said first cable diverter device for a time period T2 in the second direction, and simultaneously moving said second cable diverter mechanism for a time period T2 in the first direction;
h. Removing one or more seismic data collection devices from said cable during the time period T2;
i. Repeating steps f. through h. until a desired number of seismic collection devices have been retrieved.

17. The method of claim 16 wherein at least one of said cable diverter mechanisms is a take-up pulley.

18. The method of claim 16 wherein at least one of said cable diverter mechanisms is a spool.

19. The method of claim 16 wherein the cable dispensing and retrieving device is a reel.

20. The method of claim 16 wherein the cable dispensing and retrieving device is a squirter.

21. A system for deploying and retrieving seismic data collection equipment to and from a vessel comprising:
a. a cable having a first end and a second end;
b. a cable dispensing and retrieving device at a location between the first end of said cable and the second end of said cable;
c. a cable diverter mechanism at a location between said cable dispensing device and the first end of said cable.

22. The system of claim 21, wherein the cable diverter mechanism is a first cable diverter mechanism and further comprising:
a. a second cable diverter mechanism located between said first cable diverter mechanism and the first end of said cable.

23. The system of claim 22 wherein at least one of said cable diverter mechanisms is a take-up pulley.

24. The system of claim 22 wherein at least one of said cable diverter mechanisms is a spool.

25. The system of claim 22 wherein the cable dispensing and retrieving device is a reel.

26. The system of claim 22 wherein the cable dispensing and retrieving device is a squirter.
